(19) United States
(12) Patent Application Publication
(10) Pub. No.: US 2025/0201990 A1
(43) Pub. Date: Jun. 19, 2025

(54) BATTERY COVER, PRECURSOR OF BATTERY COVER AND METHOD FOR ASSEMBLING BATTERY COVER

(71) Applicant: 3M INNOVATIVE PROPERTIES COMPANY, St. Paul, MN (US)

(72) Inventor: Keisuke Sawamoto, Sagamiharashi (JP)

(21) Appl. No.: 18/846,371

(22) PCT Filed: Mar. 16, 2023
(86) PCT No.: PCT/IB2023/052595

§ 371 Date: Sep. 12, 2024

(30) Foreign Application Priority Data
Mar. 18, 2022 (JP) 2022-043663

(51) Int. Cl. H01M 50/202; H01M 50/24

(52) U.S. Cl. CPC H01M 50/202; H01M 50/24

(57) ABSTRACT

A battery cover includes a first side wall portion and a second side wall portion facing each other in a first direction; a third side wall portion and a fourth side wall portion facing each other in a second direction orthogonal to the first direction between the first side wall portion and the second side wall portion; and a first lid-wall portion, a second lid-wall portion, and a third lid-wall portion that are fixed in a foldable manner to first end portions of the first side wall portion, the second side wall portion, and the third side wall portion in a third direction orthogonal to the first direction and the second direction, respectively, where each of the first lid-wall portion and the third lid-wall portion includes an engagement portion, the engagement portions directly engaging with each other at the time of assembly.

The present disclosure relates to a battery cover, a precursor of the battery cover and a method for assembling the battery cover.

### BACKGROUND OF THE INVENTION

A battery cover disclosed in Patent Document 1: JP 2017-527488 A has a side wall portion that surrounds four sides of the battery and a lid-wall portion that covers an upper surface of the battery. The lid-wall portion is fixed by a fastener in a state of covering the upper surface of the battery.

### SUMMARY

### Problem to Be Solved

In the battery cover as described above, the lid-wall portion cannot be fixed in a closed state without using another member such as a fastener. Therefore, there has been a demand for a battery cover with a configuration including a smaller number of components such that the lid-wall portion can be closed without requiring a separate member such as a fastener or an adhesive. In addition, the battery cover as described above has a problem that heat flows in from a gap between the lid-wall portion and the side wall portion. On the other hand, if the number of fasteners or adhesives is increased in order to close the gap, a problem arises in that the number of components increases.

Therefore, an object of the present disclosure is to provide a battery cover, a precursor of the battery cover, and a method for assembling the battery cover with which heat insulating properties can be improved with a configuration including a smaller number of components.

### Solution to Problem

A battery cover according to one aspect of the present disclosure is a battery cover that covers a battery, the battery cover created by assembling a plurality of wall portions, the battery cover including a first side wall portion and a second side wall portion that face each other at the time of assembly in a first direction; a third side wall portion and a fourth side wall portion that face each other at the time of assembly in a second direction orthogonal to the first direction between the first side wall portion and the second side wall portion; and a first lid-wall portion, a second lid-wall portion, and a third lid-wall portion that are fixed in a foldable manner to first end portions of the first side wall portion, the second side wall portion, and the third side wall portion in a third direction orthogonal to the first direction and the second direction, respectively; where each of the first lid-wall portion and the third lid-wall portion includes an engagement portion, the engagement portions directly engaging with each other at the time of assembly; and the second lid-wall portion is held by the third lid-wall portion at the time of assembly.

A precursor of a battery cover according to one aspect of the present disclosure is a precursor of the battery cover described above, where the first side wall portion, the second side wall portion, the third side wall portion, and the fourth side wall portion are fixed in a foldable manner to each other so as to form an annular shape when viewed from the third direction, and each of the first side wall portion, the second side wall portion, the third side wall portion, the fourth side wall portion, the first lid-wall portion, the second lid-wall portion, and the third lid-wall portion spreads over or overlaps each other in a flat plate shape.

A method for assembling a battery cover according to one aspect of the present disclosure is a method for assembling a battery cover for assembling the battery cover described above, the method including a first step of, from the precursor of the battery cover, arranging the first side wall portion and the second side wall portion so as to face each other in the first direction and arranging the third side wall portion and the fourth side wall portion so as to face each other in the second direction; a second step of folding the first lid-wall portion with respect to the first side wall portion; a third step of folding the third lid-wall portion with respect to the third side wall portion to engage with the first lid-wall portion, and a fourth step of folding the second lid-wall portion with respect to the second side wall portion so that the second lid-wall portion is held by the third lid-wall portion.

### Advantageous Effects of Disclosure

According to the present disclosure, a battery cover, a precursor of the battery cover, and a method for assembling the battery cover with a configuration including a smaller number of components can be provided.

### BRIEF DESCRIPTION OF THE DRAWINGS

FIG. 1 is a perspective view illustrating a battery cover in a state in the middle of assembly;

FIG. 2 is a perspective view illustrating the battery cover in a state in which the assembly is completed;

FIG. 3 is a perspective view illustrating the battery cover in a state in which the assembly is completed;

FIG. 4 is a schematic plan view for explaining a state at the time of assembly of a lid-wall portion;

FIG. 5 is a schematic plan view for explaining a state at the time of assembly of the lid-wall portion;

FIG. 6 is a schematic plan view for explaining a state at the time of assembly of the lid-wall portion;

FIG. 7 is a cross-sectional view of a plate-like member configuring each wall portion of the battery cover;

FIG. 8(a) is a cross-sectional view of the vicinity of an opening, where the opening is formed by cutting out an end portion of the third side wall portion;

FIG. 8(b) is a cross-sectional view of the vicinity of an opening, where the opening is formed by cutting out an end portion of the fourth side wall portion;

FIG. 9(a) is a view illustrating a first portion of a precursor of the battery cover; and

FIG. 9(b) is a view illustrating a second portion of a precursor of the battery cover.

### DESCRIPTION OF EMBODIMENTS

Hereinafter, embodiments of the present disclosure will be described in detail with reference to the drawings.

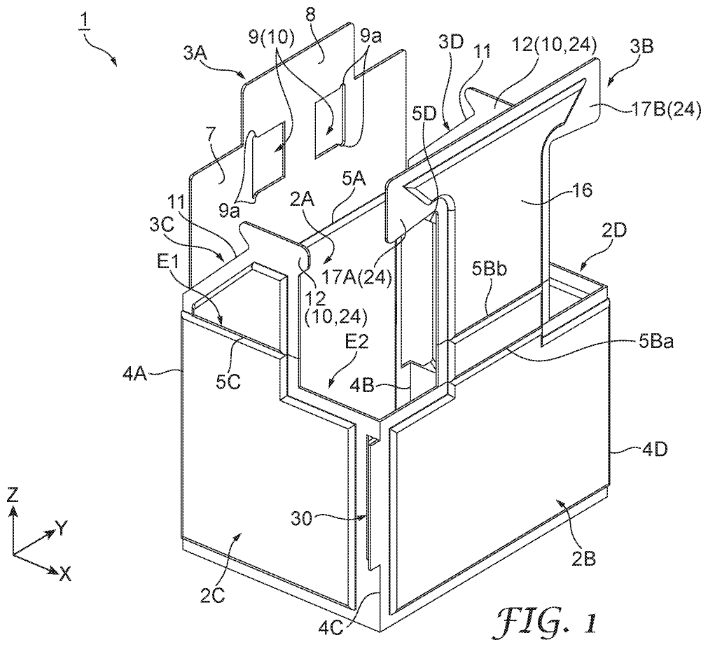

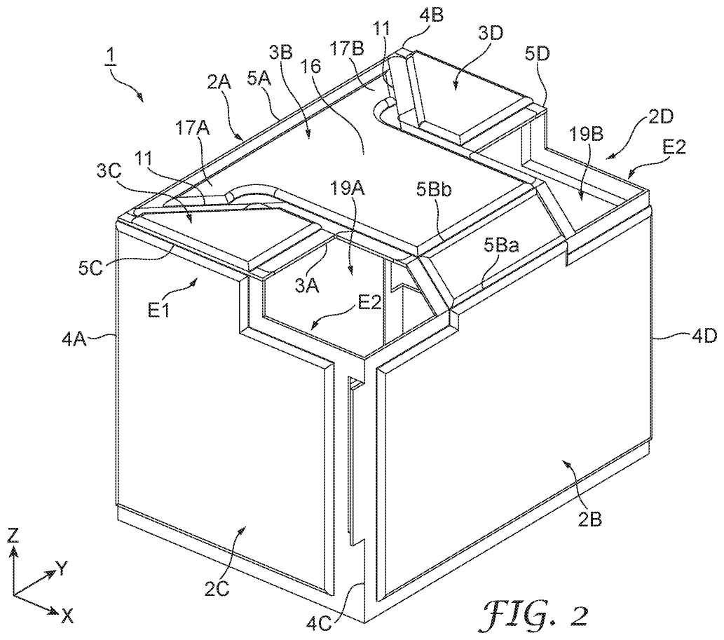

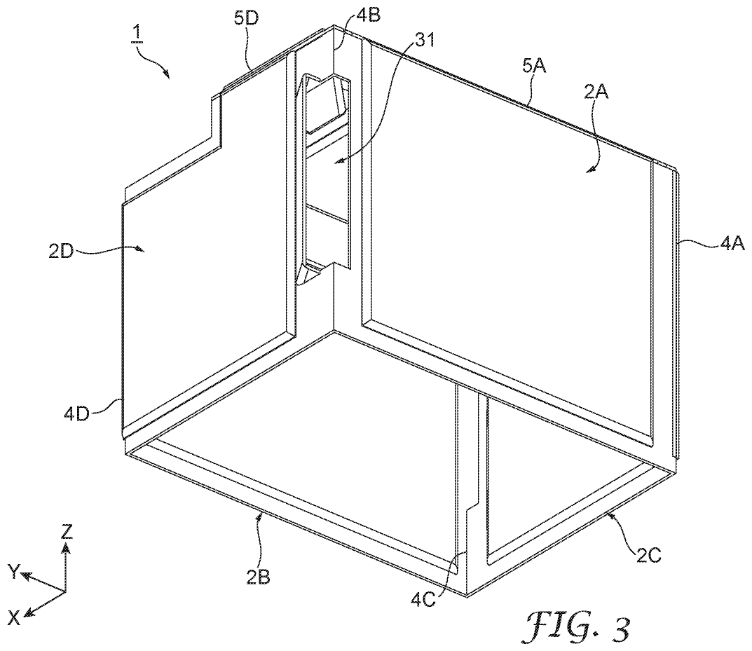

FIGS. 1 to 3 are perspective views illustrating a battery cover 1 according to an embodiment of the present disclosure. FIG. 1 is a perspective view illustrating battery cover 1 in a state in the middle of assembly. FIGS. 2 and 3 are perspective views illustrating the battery cover 1 in a state in which assembly is completed. The battery cover 1 is produced by assembling a plurality of wall portions. The battery cover 1 is created by assembling a precursor 100 of the battery cover 1. The battery cover 1 is a member that covers a battery. Note that, in the following description, XYZ coordinates are set. The X-axis direction (first direction) is a direction that is arbitrarily set. The Y-axis direction (second direction) is a direction orthogonal to the X-axis direction. The Z-axis direction (third direction) is a direction orthogonal to the X-axis direction and the Y-axis direction.

As shown in FIG. 1, the battery cover 1 includes a first side wall portion 2A, a second side wall portion 2B, a third side wall portion 2C, and a fourth side wall portion 2D. The first side wall portion 2A and the second side wall portion 2B face each other at the time of assembly in the X-axis direction. The first side wall portion 2A is disposed on the negative side in the X-axis direction. The second side wall portion 2B is disposed on the positive side in the X-axis direction. The third side wall portion 2C and the fourth side wall portion 2D face each other at the time of assembly in the Y-axis direction. The third side wall portion 2C is disposed on the negative side in the Y-axis direction. The fourth side wall portion 2D is disposed on the positive side in the Y-axis direction. Each of the side wall portions 2A, 2B, 2C, and 2D has a substantially rectangular shape. The lengths of the side wall portions 2A and 2B in the Y-axis direction are longer than the lengths of the side wall portions 2C and 2D in the X-axis.

An end portion on the negative side in the Y-axis direction of the first side wall portion 2A and an end portion on the negative side in the X-axis direction of the third side wall portion 2C are fixed so as to be foldable at a fold portion 4A, and are folded so as to be perpendicular to each other at the time of assembly. An end portion on the positive side in the Y-axis direction of the first side wall portion 2A and an end portion on the negative side in the X-axis direction of the fourth side wall portion 2D are fixed so as to be foldable at a fold portion 4B, and are folded so as to be perpendicular to each other at the time of assembly. An end portion on the negative side in the Y-axis direction of the second side wall portion 2B and an end portion on the negative side in the X-axis direction of the third side wall portion 2C are fixed so as to be foldable at a fold portion 4C, and are folded so as to be perpendicular to each other at the time of assembly. An end portion on the positive side in the Y-axis direction of the second side wall portion 2B and an end portion on the positive side in the X-axis direction of the fourth side wall portion 2D are fixed so as to be foldable at a fold portion 4D, and are folded so as to be perpendicular to each other at the time of assembly.

At the time of assembly, the end portions on the negative side in the Z-axis direction of the side wall portions 2A, 2B, 2C, and 2D are disposed at the same position in the Z-axis direction. Steps are formed at the end portions on the positive side in the Z-axis direction of the third side wall portion 2C and the fourth side wall portion 2D. Therefore, of the end portions on the positive side in the Z-axis direction of the third side wall portion 2C and the fourth side wall portion D, a region E1 on the positive side in the X-axis direction is disposed on the positive side in the Z-axis direction than a region E2 on the negative side in the X-axis direction. The end portion on the positive side in the Z-axis direction of the first side wall portion 2A is disposed at the same position as the end portion on the positive side of the region E1 in the Z-axis direction of the side wall portions 2C, 2D. The end portion on the positive side in the Z-axis direction of the second side wall portion 2B is disposed at the same position as the end portion on the positive side of the region E2 in the Z-axis direction of the side wall portions 2C, 2D.

In addition, the battery cover 1 includes a first lid-wall portion 3A, a second lid-wall portion 3B, a third lid-wall portion 3C, and a fourth lid-wall portion 3D that are fixed in a foldable manner to respective end portions on the positive side in the Z-axis direction of the first side wall portion 2A, the second side wall portion 2B, the third side wall portion 2C, and the fourth side wall portion 2D.

The end portion on the positive side in the Z-axis direction of the first side wall portion 2A and the end portion on the negative side in the Z-axis direction of the first lid-wall portion 3A are fixed so as to be foldable at a fold portion 5A, and are folded so as to be perpendicular to each other at the time of assembly (see FIG. 2). The end portion on the positive side in the Z-axis direction of the second side wall portion 2B and the end portion on the negative side in the Z-axis direction of the second lid-wall portion 3B are fixed so as to be foldable at a fold portion 5Ba, and are folded so as to incline with respect to each other at the time of assembly (see FIG. 2). Note that the second lid-wall portion 3B has a fold portion 5Bb, and the second lid-wall portion 3B is disposed to be perpendicular to the second side wall portion 2B by being folded at the fold portion 5Bb at the time of assembly. The end portion on the positive side in the Z-axis direction of the third side wall portion 2C and the end portion on the negative side in the Z-axis direction of the third lid-wall portion 3C are fixed so as to be foldable at a fold portion 5C, and are folded so as to be perpendicular to each other at the time of assembly (see FIG. 2). The end portion on the positive side in the Z-axis direction of the fourth side wall portion 2D and the end portion on the negative side in the Z-axis direction of the fourth lid-wall portion 3D are fixed so as to be foldable at a fold portion 5D, and are folded so as to be perpendicular to each other at the time of assembly (see FIG. 2).

Next, the shapes of the lid-wall portions 3A, 3B, 3C, and 3D will be described. Unless otherwise specified, the shapes of the lid-wall portions 3A, 3B, 3C, and 3D will be described with reference to a state before folding as illustrated in FIG. 1. The first lid-wall portion 3A includes a rectangular main body portion 7 extending from the first side wall portion 2A toward the positive side in the Z-axis direction, and a rectangular protruding piece 8 extending from the main body portion 7 toward the positive side in the Z-axis direction. The length of the main body portion 7 in the Y-axis direction is substantially the same as the length of the first side wall portion in the Y-axis direction. The length of the main body portion 7 in the Z-axis direction is substantially the same as the length of the region E1 of the side wall portions 2C and 2D in the X-axis direction. The protruding piece 8 is disposed at a central position in the Y-axis direction of the main body portion 7.

The first lid-wall portion 3A has a pair of rectangular openings 9 in the main body portion 7. The pair of openings 9 are arranged to be spaced apart from each other in the Y-axis direction. The pair of openings 9 extend such that the X-axis direction is the longitudinal direction. In addition, a wide width portion 9a, which has a locally wide width, is formed at an end portion on the negative side in the Y-axis direction of the opening portion 9 on the negative side in the Y-axis direction and an end portion on the positive side in the Y-axis direction of the opening 9 on the positive side in the Y-axis direction. These openings 9 functions as engagement portions 10 for directly engaging the lid-wall portions 3C, 3D with each other at the time of assembly.

The third lid-wall portion 3C has a trapezoidal shape extending from the region E1 of the first side wall portion 2A toward the positive side in the Z-axis direction. An end portion on the positive side in the X-axis direction of the third lid-wall portion 3C linearly extends to the positive side in the Z-axis direction. An end portion on the negative side in the Z-axis direction of the third lid-wall portion 3C has the same size in the X-axis direction as the region E1. An inclined edge portion 11 is formed at an end portion on the negative side in the X-axis direction of the third lid-wall portion 3C so as to extend toward the positive side in the X-axis direction as it extends toward the positive side in the Z-axis direction. The inclined edge portion 11 is arranged to be inclined with respect to the Y-axis direction at the time of assembly (see FIG. 2). A wide width portion 12 that has a locally wide width is formed at an end portion on the positive side in the Z-axis direction of the third lid-wall portion 3C. The wide width portion 12 functions as an engagement portion 10 for directly engaging the first lid-wall portion 3A with each other at the time of assembly. The fourth lid-wall portion 3D has a shape similar to that of the third lid-wall portion 3C.

The second lid-wall portion 3B includes a rectangular main body portion 16 extending from the second side wall portion 2B toward the positive side in the Z-axis direction, and substantially rectangular protruding pieces 17A and 17B extending from the main body portion 16 toward both sides in the Y-axis direction. The length of the main body portion 16 in the Y-axis direction is substantially the same as the length of the protruding piece 8 of the first lid-wall portion 3A in the Y-axis direction. The main body portion 16 is disposed at a central position of the second side wall portion 2B in the Y-axis direction. In the main body portion 16, a fold portion 5Bb is formed at a position spaced apart from the fold portion 5Ba to the positive side in the Z-axis direction. The protruding pieces 17A and 17B are disposed at end portions of the main body portion 16 in the Z-axis direction and protrude to the negative side and the positive side in the Y-axis direction, respectively.

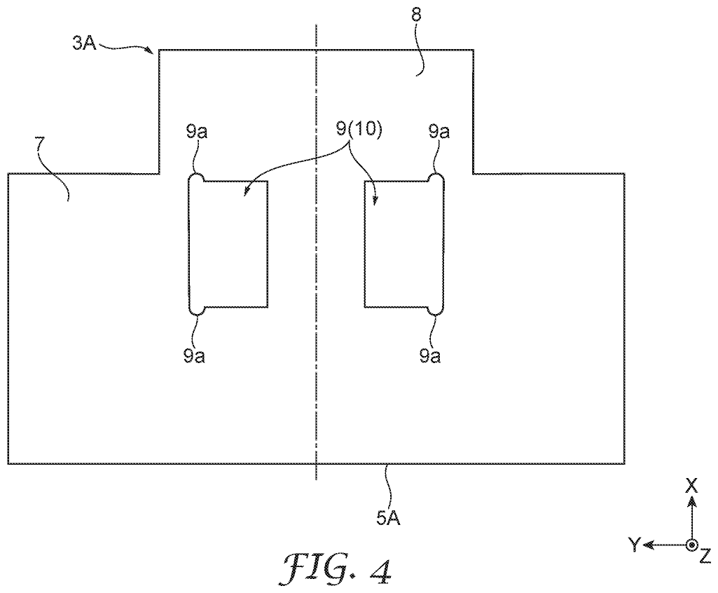

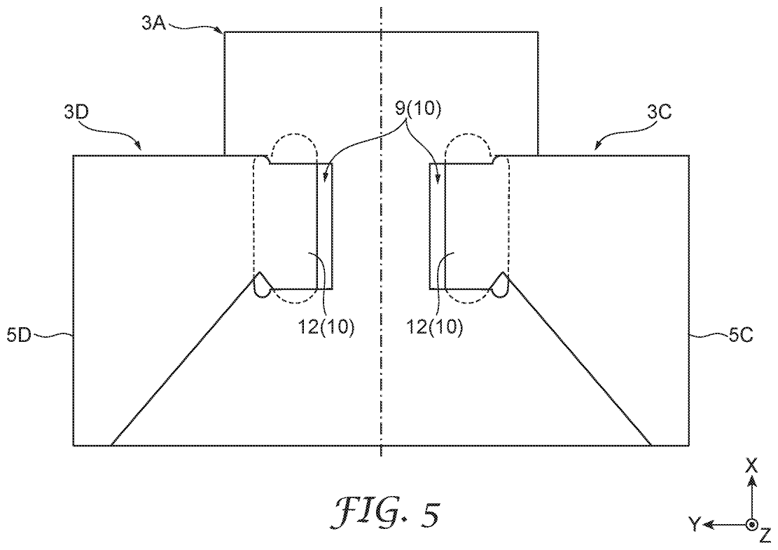

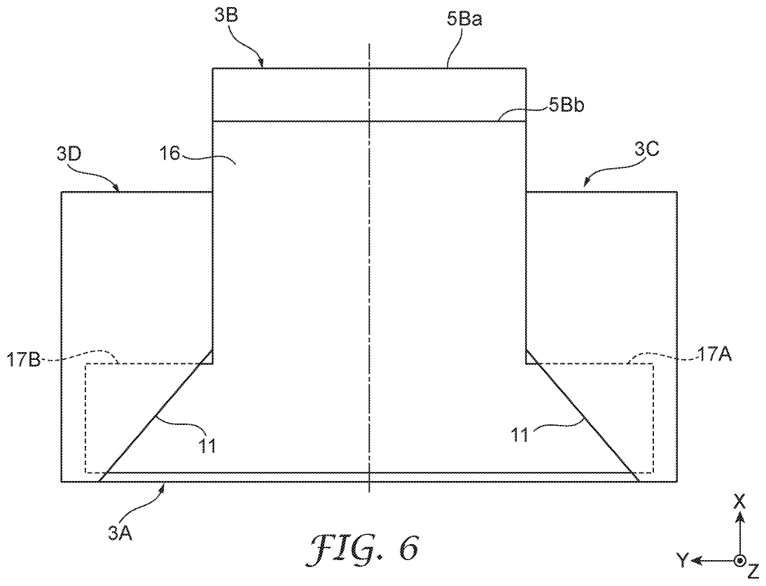

Next, a state of the lid-wall portions 3A, 3B, 3C, and 3D at the time of assembly will be described with reference to FIGS. 4 to 6. FIG. 4 shows a state in which the first lid-wall portion 3A is folded, and the other lid-wall portions 3B, 3C, and 3D are omitted. FIG. 5 shows a state in which the lid-wall portions 3C and 3D are further folded, and the second lid-wall portion 3B is omitted. FIG. 6 shows a state in which the second lid-wall portion 3B is further folded.

As shown in FIG. 4, the first lid-wall portion 3A is disposed so as to spread parallel to the XY plane by perpendicularly folding the first lid-wall portion 3A at the fold portion 5A. As shown in FIG. 5, the lid-wall portions 3C and 3D are disposed so as to spread parallel to the XY plane by perpendicularly folding the lid-wall portions 3C and 3D at the fold portions 5C and 5D. At this time, the lid-wall portions 3C and 3D are disposed so as to overlap the first lid-wall portion 3A from the positive side in the Z-axis direction. Both end portions in the X-axis direction of the wide width portions 12 of the lid-wall portions 3C and 3D are inserted into the respective openings 9. As a result, the first lid-wall portion 3A and the lid-wall portions 3C, 3D directly engage with each other by way of the engagement portion 10 at the time of assembly. The directly engaging state means a state in which the lid-wall portions 3A, 3C, and 3D are connected to each other using only the shapes of the lid-wall portions 3A, 3C, and 3D without using a separate member such as a fastener member or an adhesive.

As shown in FIG. 6, the second lid-wall portion 3B is disposed so as to spread parallel with the XY plane by folding the second lid-wall portion 3B at the fold portions 5Ba and 5Bb. At this time, the second lid-wall portion 3B is disposed so as to overlap the first lid-wall portion 3A and the lid-wall portions 3C and 3D from the positive side in the Z-axis direction. At this time, the second lid-wall portion 3B is held by the lid-wall portions 3C and 3D. The second lid-wall portion 3B is inserted into a gap between the first lid-wall portion 3A and the lid-wall portions 3C and 3D which overlap each other. Here, the lid-wall portions 3C and 3D have inclined edge portions 11 inclined with respect to the Y-axis direction at areas of holding the second lid-wall portion 3B. Therefore, the protruding piece 17A of the second lid-wall portion 3B enters the gap between the third lid-wall portion 3C and the first lid-wall portion 3A from the position of the inclined edge portion 11, and is held by being sandwiched by the third lid-wall portion 3C and the first lid-wall portion 3A. The protruding piece 17B of the second lid-wall portion 3B enters the gap between the fourth lid-wall portion 3D and the first lid-wall portion 3A from the position of the inclined edge portion 11, and is held by being sandwiched by the fourth lid-wall portion 3D and the first lid-wall portion 3A.

Since the second lid-wall portion 3B is held by the first lid-wall portion 3A and the lid-wall portions 3C and 3D as described above, the end portion of the battery cover 1 on the positive side in the Z-axis direction is covered by the lid-wall portions 3A, 3B, 3C, and 3D, as shown in FIG. 2. At this time, openings 19A and 19B are formed between the region E2 of the lid-wall portions 3C and 3D and the main body portion 16 of the second lid-wall portion 3B. The openings 19A and 19B allow terminals and the like of the battery disposed inside the battery cover 1 to be exposed to the outside. As shown in FIG. 3, the end portion of the battery cover 1 on the negative side in the Z-axis direction is opened over the entire surface.

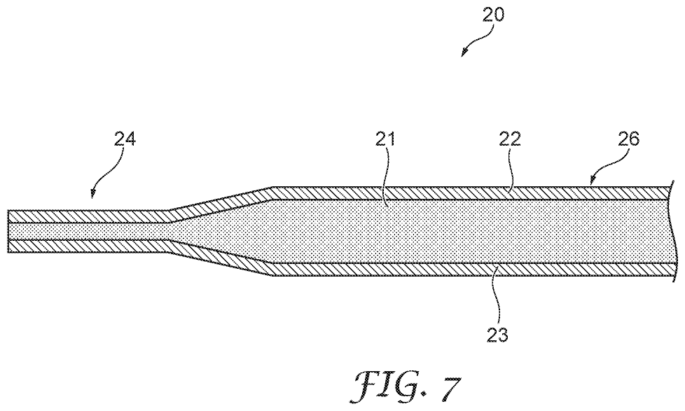

As shown in FIG. 7, the plate-like member 20 forming each wall portion of the battery cover 1 includes an intermediate layer 21 and outer layers 22 and 23. The material of the intermediate layer 21 may be, for example, a nonwoven fabric, a felt material, a urethane foam material, a microfiber, a perforated film, a fine particle bed, an open-cell foam, a fiber glass, a net, a woven fabric, or a combination thereof. The outer layers 22 and 23 may be formed of a material that prevents liquid such as water from entering inside the battery cover 1, and for example, a material such as a melt-blown nonwoven fabric, a spun-bonded nonwoven fabric, a film, a foil layer, or a combination thereof is adopted. The plate-like member 20 has a thin portion 24 subjected to a compression process and a non-processed portion 26 not subjected to a compression process. In each of the wall portions shown in FIGS. 1 to 3, the area of thick thickness is the non-processed portion 26, and the area of thin thickness is the thin portion 24. The thin portion 24 is formed at an edge portion of each wall portion.

As shown in FIG. 1, the wide width portion 12, which is the engagement portion 10, of the lid-wall portions 3C and 3D is subjected to a compression process to become the thin portion 24. The protruding pieces 17A and 17B of the second lid-wall portion 3B are subjected to the compression process to become the thin portion 24.

As illustrated in FIGS. 1 and 2, the battery cover 1 has an opening 30 open from the internal space to an external space at the time of assembly. The opening 30 is formed at a corner portion between the second side wall portion 2B and the third side wall portion 2C. At the corner portion, the opening 30 is formed to extend in the Z-axis direction. As shown in FIG. 3, the battery cover 1 has an opening 31 open from the internal space to an external space at the time of assembly. The opening 31 is formed at a corner portion between the first side wall portion 2A and the fourth side wall portion 2D. At the corner portion, the opening 30 is formed to extend in the Z-axis direction.

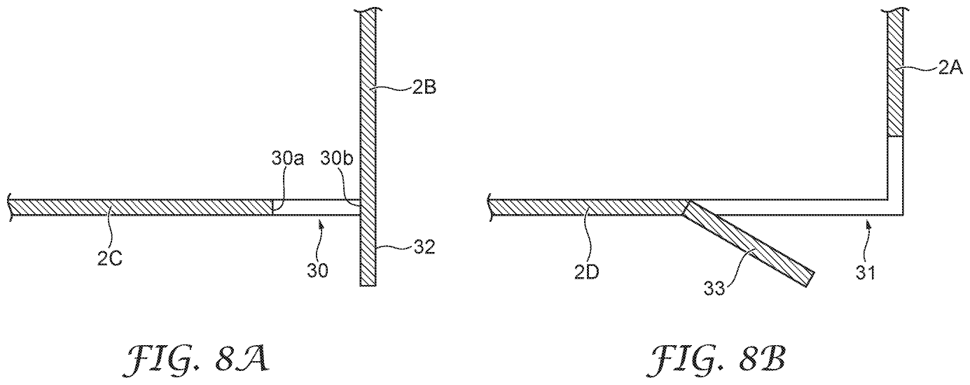

As shown in FIG. 8(a), the opening 30 is formed by cutting out an end portion of the third side wall portion 2C. The edge portion 30a of the opening 30 on the third side wall portion 2C side and the edge portion 30b on the second side wall portion 2B side face each other. A wall portion 32 rising from the opening 30 is formed at the edge portion 30b on the second side wall portion 2B side. The wall portion 32 has a configuration in which the second side wall portion 2B is extended.

As shown in FIG. 8(b), the opening 31 is formed by cutting out an end portion of the fourth side wall portion 2D and an end portion of the first side wall portion 2A. The edge portion 31a of the opening 31 on the fourth side wall portion 2D side and the edge portion 31b on the first side wall portion 2A side face each other. A wall portion 33 rising from the opening 31 is formed on the fourth side wall portion 2D. The wall portion 33 rises in a state of being inclined with respect to the fourth side wall portion 2D.

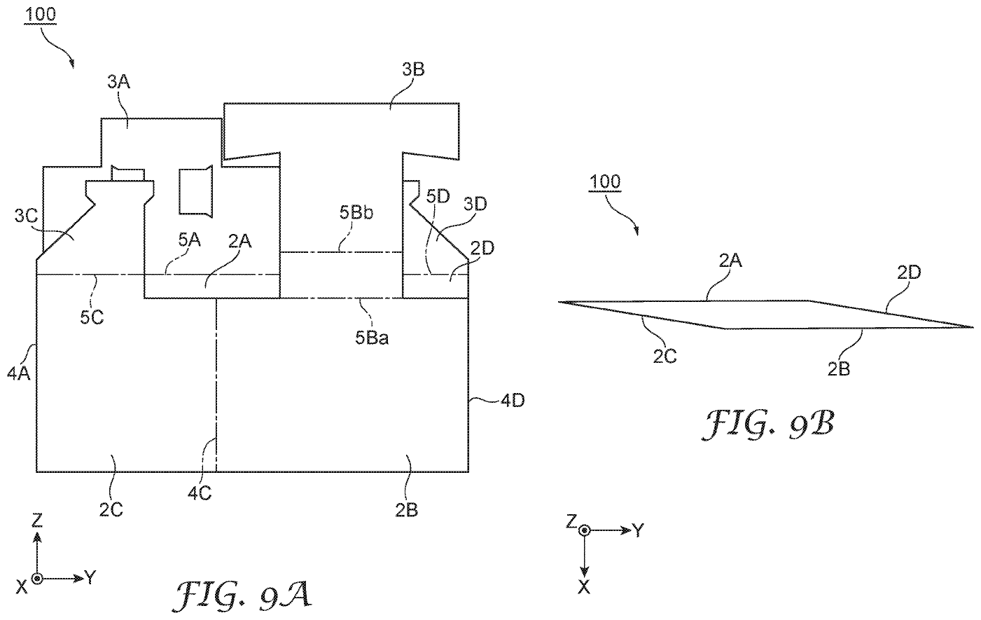

Next, the precursor 100 of the battery cover I will be described with reference to FIG. 9. Here, the XYZ-coordinates maintain the positional relationship between the first side wall portion 2A and the second side wall portion 2B from the state at the time of assembly. In the precursor 100, as shown in FIG. 9(b), the first side wall portion 2A, the second side wall portion 2B, the third side wall portion 2C, and the fourth side wall portion 2D are fixed in a foldable manner to each other so as to form an annular shape when viewed from the Z-axis direction. Furthermore, in the precursor 100, as shown in FIG. 9 (a), each of the first side wall portion 2A, the second side wall portion 2B, the third side wall portion 2C, the fourth side wall portion 2D, the first lid-wall portion 3A, the second lid-wall portion 3B, the third lid-wall portion 3C, and the fourth lid-wall portion 3D spread over or overlap each other in a flat plate shape. In the example shown in FIG. 9a, the first side wall portion 2A, the fourth side wall portion 2D, the first lid-wall portion 3A, and the fourth lid-wall portion 3D are spread in a flat plate shape. The second side wall portion 2B, the third side wall portion 2C, the second lid-wall portion 3B, and the third lid-wall portion 3C spread with respect to each other in a flat plate shape. The first side wall portion 2A, the fourth side wall portion 2D, the first lid-wall portion 3A, and the fourth lid-wall portion 3D overlap the second side wall portion 2B, the third side wall portion 2C, the second lid-wall portion 3B, and the third lid-wall portion 3C.

Next, a method for assembling the battery cover 1 will be described. The method for assembling the battery cover 1 includes a side wall portion developing step (first step) of developing the side wall portions 2A, 2B, 2C, and 2D from the precursor 100. In the side wall portion developing step, from the precursor 100 of the battery cover 1, the first side wall portion 2A and the second side wall portion 2B are arranged so as to face each other in the X-axis direction, and the third side wall portion 2C and the fourth side wall portion 2D are arranged so as to face each other in the Y-axis direction. This brings the battery cover 1 into the state shown in FIG. 1.

Next, the method for assembling the battery cover 1 includes a lid portion folding step (second step) of folding the first lid-wall portion 3A with respect to the first side wall portion 2A. Thus, as shown in FIG. 4, the first lid-wall portion 3A is perpendicular to the first side wall portion 2A. Next, the method for assembling the battery cover I includes an engaging step (third step) of folding the third lid-wall portion 3C with respect to the third side wall portion 2C to engage with the first lid-wall portion 3A, and folding the fourth lid-wall portion 3D with respect to the fourth side wall portion 2D to engage with the first lid-wall portion 3A. As a result, as illustrated in FIG. 5, the wide width portions 12 of the lid-wall portions 3C and 3D engage with the respective openings 9 of the first lid-wall portion 3A. Next, the method for assembling the battery cover 1 includes a holding step (fourth step) of folding the second lid-wall portion 3B with respect to the second side wall portion 2B so that the second lid-wall portion 3B is held by the third lid-wall portion 3C and the fourth lid-wall portion 3D. As a result, as shown in FIG. 6, the protruding pieces 17A and 17B of the second lid-wall portion 3B are held by the third lid-wall portion 3C and the fourth lid-wall portion 3D. The battery cover 1 is thereby assembled.

Next, effects of the battery cover I according to the present embodiment will be described. In the following description, “2C, 3C” are regarded as “third side wall portion and third lid-wall portion” in the claims, and “2D, 3D” are regarded as “fourth side wall portion and fourth lid-wall portion” in the claims. However, the correspondence relationship is merely for convenience, and similar effects are obtained even if “2C, 3C” are regarded as “fourth side wall portion and fourth lid-wall portion” in the claims, and “2D, 3D” are regarded as “third side wall portion and third lid- wall portion” in the claims.

First, a battery cover according to a comparative example will be described. A battery cover according to a comparative example may be a battery cover as shown in Patent Document 1. The battery cover does not have the lid-wall portion connected to the side wall portions 2B, 2C, and 2D, and has only the lid-wall portion connected to the first side wall portion. Furthermore, the lid-wall portion is fixed to the second side wall portion by way of fasteners. In such a battery cover, a fastener is required to close the lid-wall portion, and a problem that the number of components increases arises. In addition, since gaps are formed between the side wall portions 2B, 2C, 2D and the lid-wall portion, a problem that heat easily flows in from the gaps arises. Furthermore, since the side wall portions 2C and 2D do not have the lid-wall portions that also function as ribs, the side wall portions 2C and 2D are deformed so as to bulge to the outer side, thus making the gaps larger. Adding another member such as a fastener or an adhesive to reduce such a gap is problematic because the number of additional components further increases.

On the other hand, the battery cover I according to the present embodiment is a battery cover 1 that covers a battery, the battery cover I created by assembling a plurality of wall portions, and includes a first side wall portion 2A and a second side wall portion 2B facing each other at the time of assembly in an X-axis direction (first direction), and a third side wall portion 2C and a fourth side wall portion 2D facing each other at the time of assembly in a Y-axis direction (second direction) orthogonal to the X-axis direction between the first side wall portion 2A and the second side wall portion 2B. In addition, the battery cover 1 includes a first lid-wall portion 3A, a second lid-wall portion 3B, and a third lid-wall portion 3C that are fixed in a foldable manner to first end portions of the first side wall portion 2A, the second side wall portion 2B, and the third side wall portion 2C in the Z-axis direction (third direction) orthogonal to the X-axis direction and the Y-axis direction. The first lid-wall portion 3A and the third lid-wall portion 3C each has an engagement portion 10, the engagement portions 10 directly engaging with each other at the time of assembly, and the second lid-wall portion 3B is held by the third lid-wall portion 3C at the time of assembly.

The battery cover 1 according to the present embodiment includes the lid-wall portions 3A, 3B, and 3C fixed to the side wall portions 2A, 2B, and 2C, respectively. Thus, since not only the first side wall portion 2A but also the other side wall portions 2B and 2C are provided with the lid-wall portions, the gaps formed on the upper surface side of the battery cover 1 can be reduced. Furthermore, the first lid-wall portion 3A and the third lid-wall portion 3C include the engagement portions 10 that directly engage with each other at the time of assembly. Therefore, the lid-wall portions 3A and 3C can be fixed in a closed state by being engaged with each other without using a separate member such as a fastener or an adhesive. Moreover, the second lid-wall portion 3B is held by the third lid-wall portion 3C at the time of assembly. Therefore, as described above, the second lid-wall portion 3B can be fixed in a closed state without using a separate member such as a fastener or an adhesive by being held by the third lid-wall portion 3C. As described above, heat insulating properties can be improved with a configuration including a smaller number of components.

The battery cover 1 may further include a fourth lid-wall portion 3D fixed in a foldable manner to a first end portion of the fourth side wall portion 2D in the Z-axis direction. With this configuration, the gap on the upper surface side of the fourth side wall portion 2D can be reduced.

The second lid-wall portion 3B may be inserted into a gap between the first lid-wall portion 3A and the third lid-wall portion 3C that overlap each other. With this configuration, the third lid-wall portion 3C can easily hold the second lid-wall portion 3B simply by inserting the second lid-wall portion 3B into the gap.

The second lid-wall portion 3B may include the protruding pieces 17A and 17B protruding toward the third lid-wall portion 3C side. With this configuration, the second lid-wall portion 3B can be easily inserted into the gap between the first lid-wall portion 3A and the third lid-wall portion 3C.

The third lid-wall portion 3C may have the inclined edge portion 11 inclined with respect to the Y-axis direction at an area of holding the second lid-wall portion 3B. With this configuration, the second lid-wall portion 3B can be easily inserted into the gap between the first lid-wall portion 3A and the third lid-wall portion 3C.

In the second lid-wall portion 3B, an area (protruding piece 17A) held by the third lid-wall portion 3C may be subjected to a compression process. With this configuration, the second lid-wall portion 3B can be easily inserted into the gap between the first lid-wall portion 3A and the third lid-wall portion 3C.

The engagement portion 10 of the third lid-wall portion 3C may be subjected to a compression process. With this configuration, the second lid-wall portion 3B can be easily engaged with the first lid-wall portion 3A.

The openings 30 and 31 open from the internal space to an external space at the time of assembly may be provided, and wall portions 32 and 33 rising from the openings 30 and 31 may be formed on one of a pair of edge portions facing each other in the openings 30 and 31. With this configuration, the battery cover 1 can discharge the heat of the internal space to the outside from the openings 30 and 31. Furthermore, the wall portions 32 and 33 can suppress external heat from entering from the openings 30 and 31.

The precursor 100 of the battery cover 1 according to one aspect of the present embodiment is the precursor 100 of the battery cover 1 described above, where the first side wall portion 2A, the second side wall portion 2B, the third side wall portion 2C, and the fourth side wall portion 2D are fixed in a foldable manner to each other so as to form an annular shape when viewed from the Z-axis direction, and each of the first side wall portion 2A, the second side wall portion 2B, the third side wall portion 2C, the fourth side wall portion 2D, the first lid-wall portion 3A, the second lid-wall portion 3B, and the third lid-wall portion 3c spread over or overlap each other in a flat plate shape.

According to the precursor of the battery cover 1, the battery cover 1 as described above can be easily assembled, and the same operations and effects as those of the battery cover 1 can be obtained.

A method for assembling the battery cover 1 according to one aspect of the present embodiment is a method for assembling the battery cover 1 for assembling the battery cover 1 described above, the method including: a first step of, from the precursor 100 of the battery cover 1, arranging the first side wall portion 2A and the second side wall portion 2B so as to face each other in the X-axis direction, and arranging the third side wall portion 2C and the fourth side wall portion 2D so as to face each other in the Y-axis direction: a second step of folding the first lid-wall portion 3A with respect to the first side wall portion 2A: a third step of folding the third lid-wall portion 3C with respect to the third side wall portion 2C to engage with the first lid-wall portion 3A: and a fourth step of folding the second lid-wall portion 3B with respect to the second side wall portion 2B so that the second lid-wall portion 3B is held by the third lid-wall portion 3C.

According to the method for assembling the battery cover 1, the battery cover 1 as described above can be easily assembled, and the same effect as the battery cover 1 can be obtained.

The present disclosure is not intended to be limited to the embodiments described above.

For example, the shape and size of the battery cover 1 according to the embodiment described above are merely examples, and may be appropriately changed without departing from the gist of the present disclosure.

For example, one of the third lid-wall portion 3C and the fourth lid-wall portion 3D may be omitted.

In order to fix the lid-wall portion, another member such as a fastener or an adhesive may be added in an auxiliary manner within a range in which the number of components does not excessively increase.

### Reference Signs List

1. battery cover, 2A. first side wall portion, 2B. second side wall portion, 2C. third side wall portion, 2D. fourth side wall portion, 3A. first lid-wall portion, 3B. second lid-wall portion, 3C. third lid-wall portion, 3D. fourth lid-wall portion, 10. engagement portion, 11. inclined edge portion, 17A, 17B. protruding piece, 30, 31. opening, 32, 33. wall portion, 100. precursor.

1. A battery cover for covering a battery, the battery cover created by assembling a plurality of wall portions, the battery cover comprising:
a first side wall portion and a second side wall portion that face each other at the time of assembly in a first direction;
a third side wall portion and a fourth side wall portion that face each other at the time of assembly in a second direction orthogonal to the first direction between the first side wall portion and the second side wall portion; and
a first lid-wall portion, a second lid-wall portion, and a third lid-wall portion that are fixed in a foldable manner to first end portions of the first side wall portion, the second side wall portion, and the third side wall portion in a third direction orthogonal to the first direction and the second direction, respectively; wherein
each of the first lid-wall portion and the third lid-wall portion includes an engagement portion, the engagement portions directly engaging with each other at the time of assembly, and the second lid-wall portion is held by the third lid-wall portion at the time of assembly.

2. The battery cover according to claim 1, further comprising a fourth lid-wall portion fixed in a foldable manner to a first end portion of the fourth side wall portion in the third direction.

3. The battery cover according to claim 1, wherein the second lid-wall portion is inserted into a gap between the first lid-wall portion and the third lid-wall portion which overlap each other.

4. The battery cover according to claim 1, wherein the second lid-wall portion includes a protruding piece protruding toward the third lid-wall portion.

5. The battery cover according to claim 1, wherein the third lid-wall portion has an inclined edge portion inclined with respect to the second direction at a position of holding the second lid-wall portion.

6. The battery cover according to claim 1, wherein an area of the second lid-wall portion held by the third lid-wall portion is subjected to a compression process.

7. The battery cover according to claim 1, wherein the engagement portion of the third lid-wall portion is subjected to a compression process.

8. The battery cover according to claim 1, further comprising:
an opening open from an internal space to an external space at the time of assembly, wherein
a wall portion rising from the opening is formed on one of a pair of edge portions facing each other in the opening.

9. A precursor of the battery cover described in claim 1, wherein
the first side wall portion, the second side wall portion, the third side wall portion, and the fourth side wall portion are fixed in a foldable manner to each other so as to form an annular shape when viewed from the third direction, and
each of the first side wall portion, the second side wall portion, the third side wall portion, the fourth side wall portion, the first lid-wall portion, the second lid-wall portion, and the third lid-wall portion spread over or overlap each other in a flat plate shape.

10. A method for assembling a battery cover for assembling the battery cover described in claim 1, the method comprising:
a first step of, from the precursor of the battery cover, arranging the first side wall portion and the second side wall portion so as to face each other in the first direction, and arranging the third side wall portion and the fourth side wall portion so as to face each other in the second direction;
a second step of folding the first lid-wall portion with respect to the first side wall portion;
a third step of folding the third lid-wall portion with respect to the third side wall portion to engage the third lid-wall portion with the first lid-wall portion; and
a fourth step of folding the second lid-wall portion with respect to the second side wall portion so that the second lid-wall portion is held by the third lid-wall portion.
